(19) United States
(12) Patent Application Publication
(10) Pub. No.: US 2017/0032017 A1
(43) Pub. Date: Feb. 2, 2017

(54) MULTIDIMENSIONAL DATA VISUALIZATION APPARATUS, METHOD, AND PROGRAM

(71) Applicant: NEC CORPORATION, Tokyo (JP)

(72) Inventors: Satoshi MORINAGA, Tokyo (JP); Yoshinobu KAWAHARA, Osaka (JP); Takayuki ITOH, Tokyo (JP); Yunzhu ZHENG, Tokyo (JP); Haruka SUEMATSU, Tokyo (JP)

(73) Assignee: NEC CORPORATION, Tokyo (JP)

(21) Appl. No.: 13/977,186

(22) PCT Filed: Dec. 21, 2012
(86) PCT No.: PCT/JP2012/008195

§ 371 Date: Jun. 28, 2013

(30) Foreign Application Priority Data
Feb. 3, 2012 (JP) 2012-022112

(51) Int. Cl. G06F 17/30

(52) U.S. Cl. CPC G06F 17/30598; G06F 17/30592; G06F 17/30554

(57) ABSTRACT

A multidimensional data visualization apparatus capable of visualizing a data distribution in an input space of high-dimensional data so as to enable understanding of relationships between input dimensions is provided. Low-dimensional parallel coordinates plot creation element 71 creates, from input multidimensional data, a plurality of low-dimensional parallel coordinates plots that are each a graph in which data relating to part of dimensions in the multidimensional data is represented by a parallel coordinates plot. Feature value computation element 72 computes, for each pair of low-dimensional parallel coordinates plots, a feature value indicating a relationship between the low-dimensional parallel coordinates plots forming the pair. Coordinate computation element 73 computes coordinates at which each low-dimensional parallel coordinates plot is arranged, based on the feature value computed by the feature value computation element 72.

### TECHNICAL FIELD

The present invention relates to a multidimensional data visualization apparatus, a multidimensional data visualization method, and a multidimensional data visualization program. The present invention particularly relates to a multidimensional data visualization apparatus, method, and program for visualizing a distribution of high-dimensional data, the whole of which is difficult for humans to recognize at one time, by representing it by a plurality of PCPs (Parallel Coordinates Plot).

### BACKGROUND ART

With the rapid development of data infrastructures in recent years, one of the main issues for the industry is efficient processing of large-size and large-volume data. In data analysis, it is extremely important for an analyzer to understand a distribution and statistical properties of data. Data visualization techniques are crucial for this purpose. In the case where the number of dimensions of data is more than three, the data cannot be directly visualized using a scatter plot or the like. Hence, a major challenge associated with visualization techniques is to realize a method for visualizing high-dimensional data.

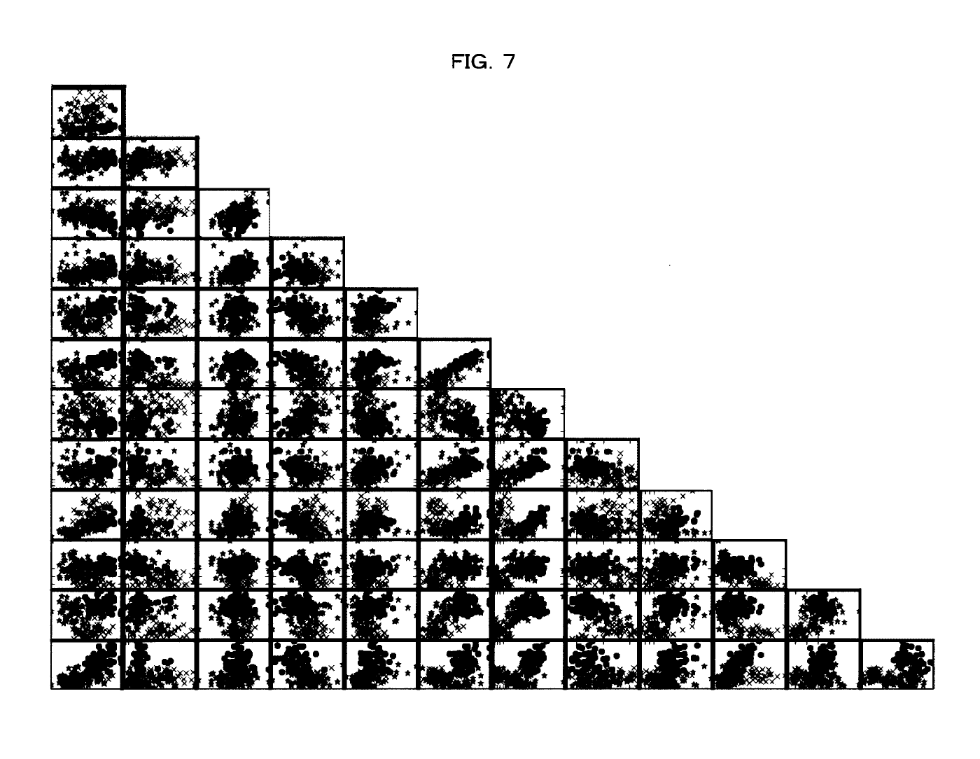

An example of the multidimensional data visualization technique is a scatter plot matrix (hereafter referred to as “SP matrix”). In the SP matrix, a screen is divided in a grid, and a plurality of two-dimensional scatter plots (hereafter also abbreviated as “SP”) obtained from multidimensional data are arranged in division areas. An example of multidimensional data visualization by the scatter plot matrix is illustrated in FIG. 7. FIG. 7 shows an example of the case where 13-dimensional data is visualized by the scatter plot matrix.

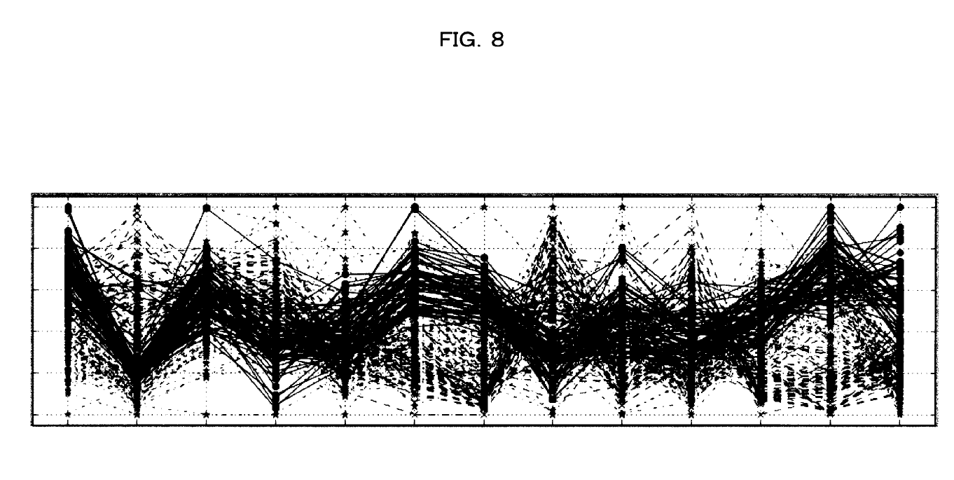

Another example of the multidimensional data visualization technique is a PCP (Parallel Coordinates Plot) (see Non Patent Literature (NPL) 1). The PCP is a graph in which axes corresponding to individual dimensions are positioned in parallel, and values on the axes are connected by inter-axis line segments to visualize multidimensional data. FIG. 8 shows an example of the PCP that represents the 13-dimensional data shown in FIG. 7.

Moreover, a technique regarding layout of a plurality of graphs is described in NPL 2.

Furthermore, Isomap is described in NPL 3 as a technique related to the present invention.

### CITATION LIST

### Non Patent Literature(s)

NPL 1: Alfred Inselberg, Bernard Dimsdale, “Parallel Coordinates: A Tool for Visualizing Multi-dimensional Geometry”, WEE Visualization '90

NPL 2: T. Itoh, C. Muelder, K.-L. Ma, J. Sese, “A Hybrid Space-Filling and Force-Directed Layout Method for Visualizing Multiple-Category Graphs”, IEEE Pacific Visualization Symposium, pp. 121-128, 2009

NPL 3: J. B. Tenenbaum, V. de Silva, C. Langford, “A Global Geometric Framework for Nonlinear Dimensionality Reduction”, Science Vol. 290 (5500) pp. 2319-2323, Dec. 22, 2000

### SUMMARY OF INVENTION

### Technical Problem

In the SP matrix, a plurality of two-dimensional scatter plots obtained from multidimensional data are arranged in a grid. Accordingly, when data is higher-dimensional (e.g. when the number of dimensions of data exceeds several dozen), the size of each grid cell is smaller, which causes a decrease in visibility.

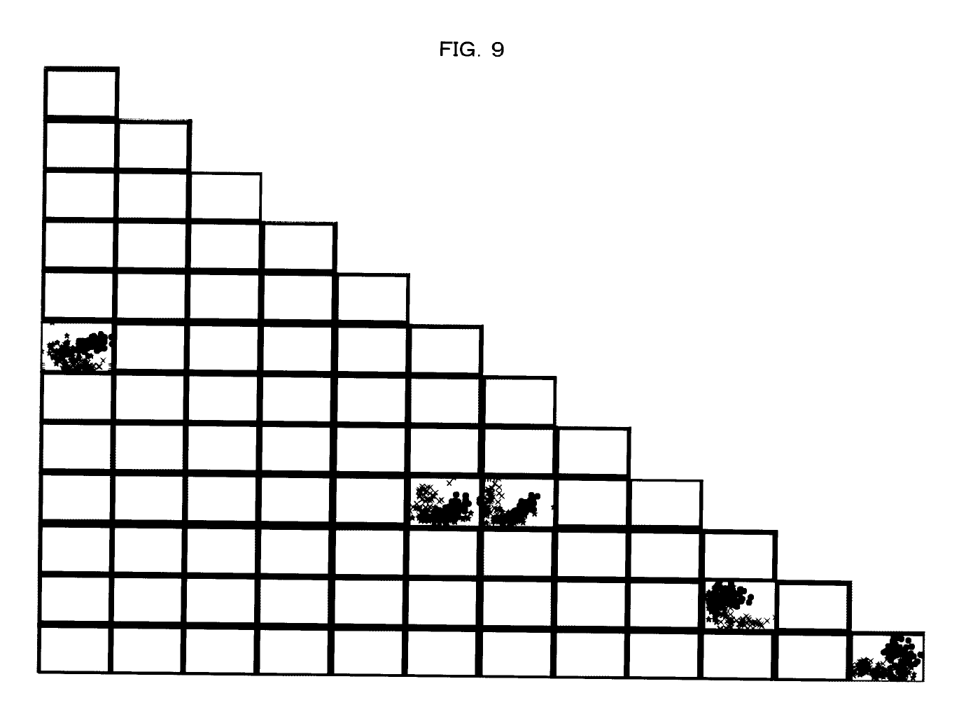

This raises a possibility of combining the SP matrix with dimension selection. For example, in the case where input data is 100-dimensional, only 10 dimensions of the 100 dimensions may be selected and displayed by the SP matrix. However, there are a problem that most pairs of the selected dimensions have little information in many cases, and a problem that relationships between two-dimensional scatter plots (i.e. relationships between input dimensions) are hard to understand. The following describes an example of such problems. FIG. 9 is a diagram showing, with regard to the same data as the data shown in FIG. 7, top five subplots with low class label entropy (in other words, subplots where data of each class can be favorably isolated) by highlight. As can be seen from FIG. 9, in the SP matrix, subplots having the same information are not always displayed at close positions. This makes it extremely difficult to understand relationships between input dimensions (i.e. between dimensions in input multidimensional data).

In the PCP (see FIG. 8), there is the following problem. Since relationships between axes not adjacent to each other are hard to understand in the PCP, it is impossible to sufficiently represent phenomena in data that is highly correlated with three or more axes. Besides, an increase in the number of dimensions causes a problem that a screen space which is horizontally very long is required.

In view of the above, the present invention has an object of providing a multidimensional data visualization apparatus, a multidimensional data visualization method, and a multidimensional data visualization program capable of visualizing a data distribution in an input space of high-dimensional data so as to enable understandin of relationships between input dimensions.

### Solution to Problem

A multidimensional data visualization apparatus according to the present invention includes: low-dimensional parallel coordinates plot creation means for creating, from input multidimensional data, a plurality of low-dimensional parallel coordinates plots that are each a graph in which data relating to part of dimensions in the multidimensional data is represented by a parallel coordinates plot; feature value computation means for computing, for each pair of low-dimensional parallel coordinates plots, a feature value indicating a relationship between the low-dimensional parallel coordinates plots forming the pair; and coordinate computation means for computing coordinates at which each low-dimensional parallel coordinates plot is arranged, based on the feature value computed by the feature value computation means.

A multidimensional data visualization method according to the present invention includes: creating, from input multidimensional data, a plurality of low-dimensional parallel coordinates plots that are each a graph in which data relating to part of dimensions in the multidimensional data is represented by a parallel coordinates plot; computing, for each pair of low-dimensional parallel coordinates plots, a feature value indicating a relationship between the low-dimensional parallel coordinates plots forming the pair; and computing coordinates at which each low-dimensional parallel coordinates plot is arranged, based on the feature value.

A multidimensional data visualization program according to the present invention causes a computer to execute: a low-dimensional parallel coordinates plot creation process of creating, from input multidimensional data, a plurality of low-dimensional parallel coordinates plots that are each a graph in which data relating to part of dimensions in the multidimensional data is represented by a parallel coordinates plot; a feature value computation process of computing, for each pair of low-dimensional parallel coordinates plots, a feature value indicating a relationship between the low-dimensional parallel coordinates plots forming the pair; and a coordinate computation process of computing coordinates at which each low-dimensional parallel coordinates plot is arranged, based on the feature value computed in the feature value computation process.

### Advantageous Effects of Invention

According to the present invention, a data distribution in an input space of high-dimensional data can be visualized so as to enable understanding of relationships between input dimensions.

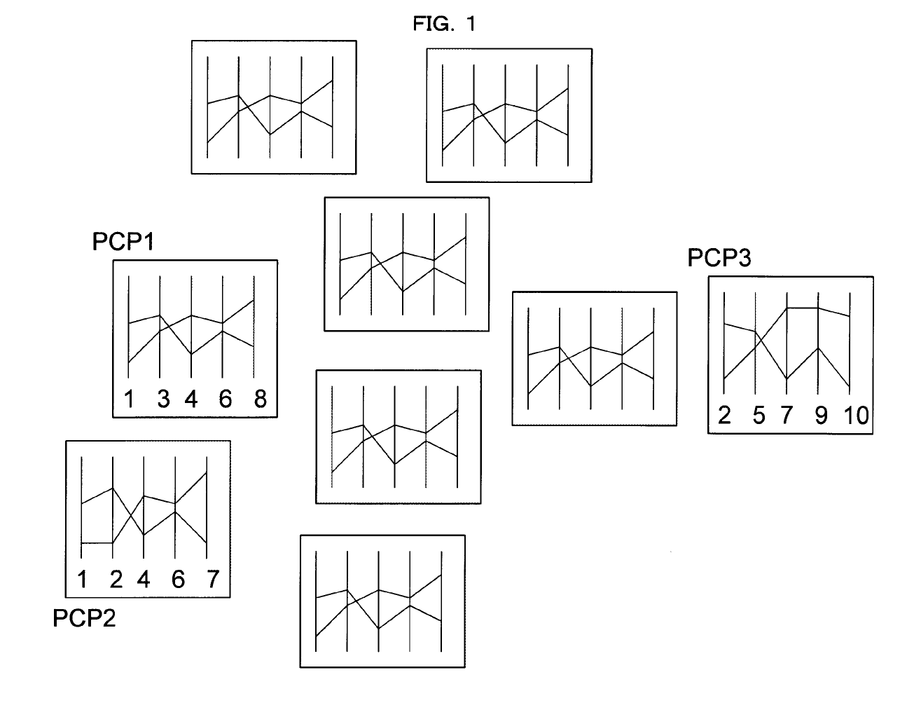

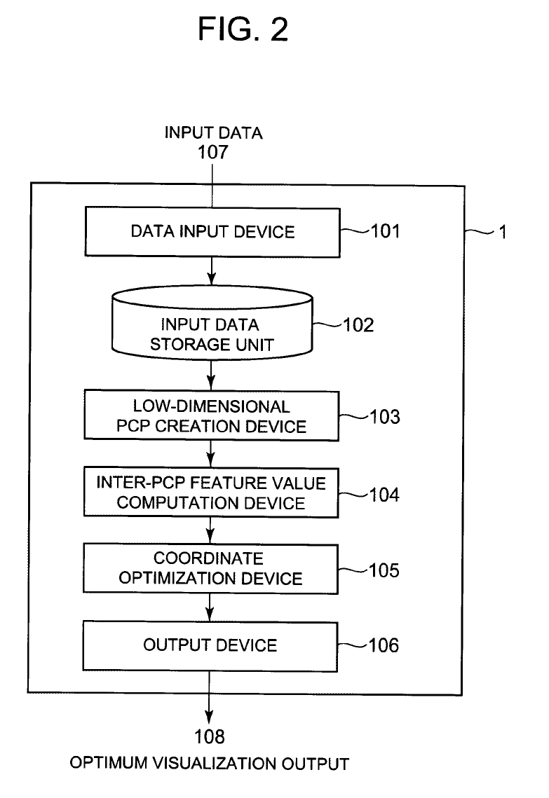

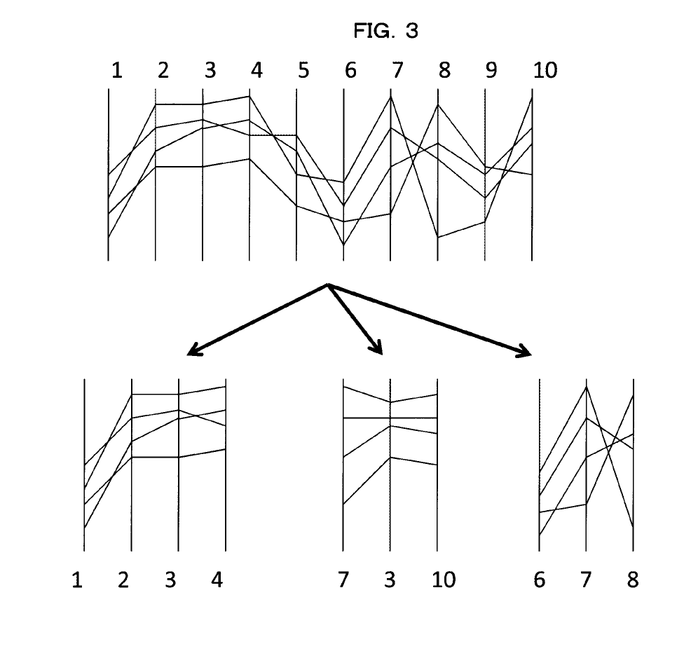

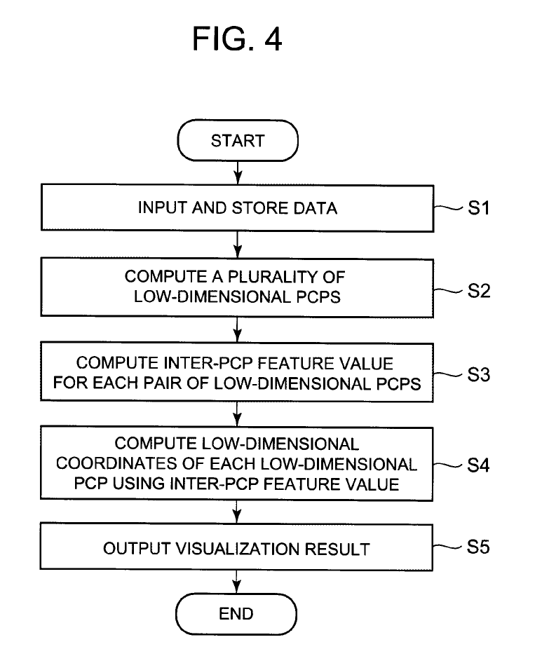

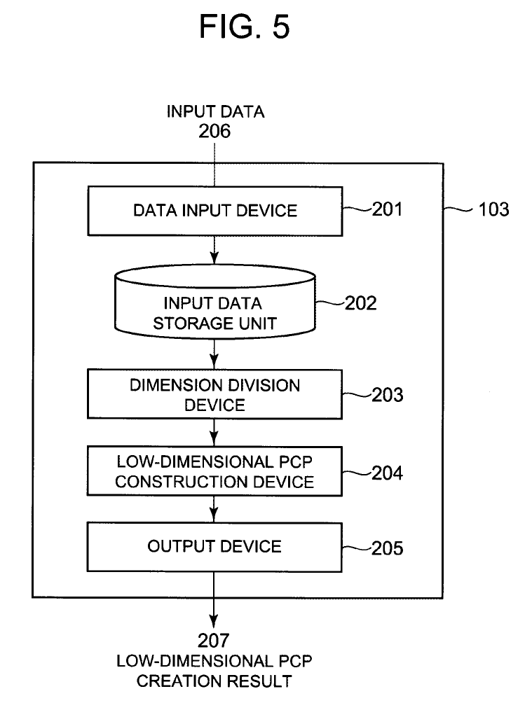

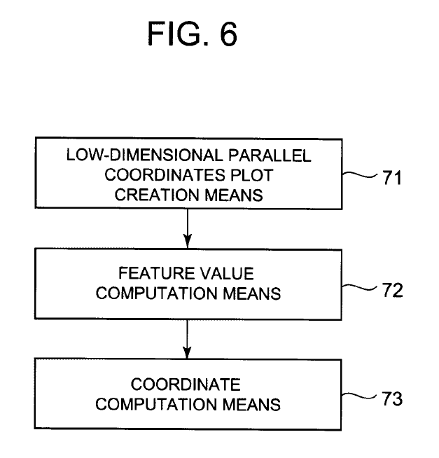

### BRIEF DESCRIPTION OF DRAWINGS

[FIG. 1] It depicts a schematic diagram schematically showing an example of an output screen according to the present invention.

[FIG. 2] It depicts a block diagram showing an example of a multidimensional data visualization apparatus according to the present invention.

[FIG. 3] It depicts an explanatory diagram showing an example of a PCP of high-dimensional data and a plurality of low-dimensional PCPs obtained from the high-dimensional data.

[FIG. 4] It depicts a flowchart showing an example of a procedure according to the present invention.

[FIG. 5] It depicts a block diagram showing an example of a structure of a low-dimensional PCP creation device 103.

[FIG. 6] It depicts a block diagram showing an example of a minimum structure of a multidimensional data visualization apparatus according to the present invention.

[FIG. 7] It depicts an explanatory diagram showing an example of multidimensional data visualization by a scatter plot matrix.

[FIG. 8] It depicts an explanatory diagram showing an example of a PCP.

[FIG. 9] It depicts a diagram showing, with regard to the same data as the data shown in FIG. 7, top five subplots with low class label entropy by highlight.

### DESCRIPTION OF EMBODIMENT(S)

The following describes an exemplary embodiment of the present invention with reference to drawings.

A multidimensional data visualization apparatus according to the present invention creates, from multidimensional data, a plurality of PCPs that are lower-dimensional than the number of dimensions of the multidimensional data (hereafter such PCPs are also referred to as “low-dimensional PCPs” or “low-dimensional parallel coordinates plots”). The multidimensional data visualization apparatus arranges the plurality of low-dimensional PCPs on a screen to visualize the multidimensional data, as illustrated in FIG. 1.

When arranging the plurality of low-dimensional PCPs on the screen, the multidimensional data visualization apparatus according to the present invention arranges low-dimensional PCPs having similar features, close to each other. Thus, relationships between input dimensions (dimensions in the input multidimensional data) can be represented by the arrangement of the low-dimensional PCPs.

FIG. 2 is a block diagram showing an example of the multidimensional data visualization apparatus according to the present invention. A multidimensional data visualization apparatus 1 according to the present invention includes a data input device 101, an input data storage unit 102, a low-dimensional PCP creation device 103, an inter-PCP feature value computation device 104, a coordinate optimization device 105, and an output device 106.

The multidimensional data visualization apparatus 1 receives input data 107, and outputs an optimum visualization output 108. The input data 107 is multidimensional data, and the optimum visualization output 108 is a result of arranging a plurality of low-dimensional PCPs created based on the multidimensional data.

The data input device 101 is an inteiface device for inputting the input data 107. The input data 107 is multidimensional data, as mentioned above. It is assumed here that the multidimensional data input as the input data 107 is multidimensional data of D dimensions. The number of pieces of data of the multidimensional data input as the input data 107 is denoted by N.

The multidimensional data is, for instance, the following data. As an example, D-dimensional data having N points is obtained from N cars each having D sensors. As another example, D-dimensional data having N points is obtained from N patients each having D types of health examination information. Such N pieces of D-dimensional data can be used as the input data 107. Note that the two kinds of D-dimensional data described here are illustrative only, and the input data 107 is not limited to these examples.

Upon input of the input data 107, a parameter necessary for analysis may also be input to the data input device 101. An example of the parameter necessary for analysis is a parameter for designating the type of an inter-PCP feature value described later. Moreover, for example in the case where the coordinate optimization device 105 uses principal component analysis or Isomap, an input parameter of principal component analysis or Isomap may be input together with the input data 107. Note that the type of the parameter input together with the input data 107 is not particularly limited.

The input data storage unit 102 is a storage device for storing the input data 107 input to the data input device 101.

The low-dimensional PCP creation device 103 creates low-dimensional PCPs for high-dimensional data (in detail, the D-dimensional data input as the input data 107), by a predetermined method.

FIG. 3 is an explanatory diagram showing an example of a PCP of high-dimensional data and a plurality of low-dimensional PCPs obtained from the high-dimensional data. The upper part of FIG. 3 shows a PCP of 10-dimensional data, as the PCP of the high-dimensional data. In the PCP of the 10-dimensional data, axes 1 to 10 are arranged so that highly correlated axes are adjacent to each other. However, though axis 3 also has a high correlation with an axis other than axes 2 and 4 in the PCP of the 10-dimensional data (see the upper part of FIG. 3), such a correlation is difficult to read from the PCP shown in the upper part of FIG. 3. On the other hand, for example suppose the PCP of the 10-dimensional data is divided into three low-dimensional PCPs so that axis 3 overlaps between a plurality of sets of low-dimensional data, as shown in the lower part of FIG. 3. In this case, the characteristics of axis 3 correlated with many axes can be represented appropriately.

The low-dimensional PCP creation device 103 may omit each axis not correlated with any axis from the display, when creating the low-dimensional PCPs. Such omission of each axis not correlated with any axis from all low-dimensional PCPs enables only information whose visualization is of great significance to be displayed.

In addition, while the PCP of the 10-dimensional data is a horizontally long graph as shown in the upper part of FIG. 3, dividing the PCP into the low-dimensional PCPs contributes to efficient screen space utilization according to, for example, the size or aspect ratio of a display device.

The inter-PCP feature value computation device 104 computes, for each pair of low-dimensional PCPs created by the low-dimensional PCP creation device 103, a feature value indicating a relationship between the low-dimensional PCPs (hereafter referred to as “inter-PCP feature value”), by a predetermined method. That is, the inter-PCP feature value computation device 104 computes, for each pair of low-dimensional PCPs, an inter-PCP feature value of the low-dimensional PCPs forming the pair. The inter-PCP feature value is determined according to from which viewpoint the low-dimensional PCPs are arranged on the screen for visualization.

An example of the inter-PCP feature value is described below, with reference to FIG. 1. PCPs 1, 2, and 3 shown in FIG. 1 and the other PCPs shown in FIG. 1 are each a low-dimensional PCP. The axes in PCPs 1 and 2 are given axis numbers in FIG. 1, for ease of explanation. PCPs 1 and 2 share many axes. In detail, PCPs 1 and 2 both have five axes, of which three axes (i.e. axes 1, 4, and 6) are common. Accordingly, by arranging PCPs 1 and 2 close to each other on the screen, it is possible to visualize in which subspace a correlation appears. Meanwhile, PCP 3 has a different correlation tendency from PCPs 1 and 2, and so is preferably arranged at a position far from the PCPs 1 and 2 on the screen. For example, the inter-PCP feature value computation device 104 may compute the inter-PCP feature value that enables such arrangement, in the following manner. For each low-dimensional PCP, the inter-PCP feature value computation device 104 computes a correlation coefficient for each class label, and computes a vector (hereafter referred to as “correlation coefficient vector”) by vectoring the correlation coefficient for each class label. The inter-PCP feature value computation device 104 then computes a correlation coefficient vector distance for each pair of low-dimensional PCPs. The correlation coefficient vector distance computed in this way can be used as the inter-PCP feature value.

An example of computation of the correlation coefficient for each class label by the inter-PCP feature value computation device 104 is described below. The case of focusing on three axes (denoted by axes a to c) is used here as an example. It is assumed that axes a to c are ordered from left in the low-dimensional PCP, for example.

The inter-PCP feature value computation device 104 may compute a correlation coefficient between each pair of axes that are adjacent in the order from among the three axes, and compute a mean of the correlation coefficients. In this example, the inter-PCP feature value computation device 104 may compute a correlation coefficient between axes a and b and a correlation coefficient between axes b and c, and compute a mean of the correlation coefficients.

Alternatively, the inter-PCP feature value computation device 104 may compute a correlation coefficient between each pair of axes from among the three axes, and compute a mean of the correlation coefficients. In this example, the inter-PCP feature value computation device 104 may compute a correlation coefficient between axes a and b, a correlation coefficient between axes b and c, and a correlation coefficient between axes a and c, and compute a mean of the correlation coefficients.

Alternatively, the inter-PCP feature value computation device 104 may use an eigenvalue of a covariance matrix as a correlation coefficient. In this example, the inter-PCP feature value computation device 104 may compute a covariance matrix (3×3 matrix in this case) from the above-mentioned three axes a to c, and use an eigenvalue of the covariance matrix or a square root of the eigenvalue of the covariance matrix as a correlation coefficient.

Note that the above-mentioned correlation coefficient computation methods are illustrative only, and the correlation coefficient computation method is not limited to the above examples.

Moreover, the above-mentioned correlation coefficient vector distance is an example of the inter-PCP feature value, and a value other than the correlation coefficient vector distance may be computed as the inter-PCP feature value. Though the above describes the case of using the correlation coefficient vector to obtain the inter-PCP feature value as an example, the inter-PCP feature value computation device 104 may compute the inter-PCP feature value from a vector other than the correlation coefficient vector. A vector computed for each low-dimensional PCP in order to compute the inter-PCP feature value is referred to as “inter-PCP feature value vector”. The above-mentioned correlation coefficient vector is an example of the inter-PCP feature value vector.

The inter-PCP feature value computation device 104 may also change the type of the inter-PCP feature value to be computed, according to the parameter input to the data input device 101.

The coordinate optimization device 105 optimizes the arrangement of each low-dimensional PCP in a low-dimensional coordinate space, based on the inter-PCP feature value computed by the inter-PCP feature value computation device 104. For example, the coordinate optimization device 105 decides optimum coordinates for arranging each low-dimensional PCP in a two-dimensional space.

A dimension compression technique exemplified by principal component analysis, Isomap (see NPL 3), and the like is available as the method of computing the optimum coordinates of each low-dimensional PCP. Examples of the computation method of the optimum coordinates for arranging each low-dimensional PCP are described below.

An example of the coordinate computation method using principal component analysis is described first. In this method, the coordinate optimization device 105 computes a covariance matrix from the inter-PCP feature value vector. The coordinate optimization device 105 then solves an eigenvalue problem of the covariance matrix, to compute principal component vectors. The coordinate optimization device 105 projects the inter-PCP feature value vector in a direction of a designated principal component vector (e.g. higher-order two-dimensional principal component vector), thereby computing the optimum coordinates of the low-dimensional PCP.

An example of the coordinate computation method using Isomap is described next. In this method, the coordinate optimization device 105 computes a distance matrix from the inter-PCP feature value vector. A typical example of the distance used to compute the distance matrix is an Euclidean distance, or a geodesic distance using a graph. The coordinate optimization device 105 solves an eigenvalue problem of the computed distance matrix, thereby computing embedded coordinates (low-dimensional coordinates) of the inter-PCP feature value vector.

Alternatively, the coordinate optimization device 105 may compute the coordinates for arranging each low-dimensional PCP, through the use of the technique described in NPL 2. In this method, the coordinate optimization device 105 creates a network structure for connecting each low-dimensional PCP. An example of the network structure creation method is a method of connecting, from among arbitrary low-dimensional PCP pairs, a fixed number of pairs having a close correlation coefficient vector distance, by links. Whether or not the correlation coefficient vector distance is close may be determined by comparing the correlation coefficient vector distance with a threshold. Following this, the coordinate optimization device 105 assumes the same mechanics as springs for the created links, and decides a provisional position of each PCP in the low-dimensional space through iterative computation of a motion equation. The coordinate optimization device 105 further applies a rectangular space filling technique with reference to the provisional position, to decide the position of each low-dimensional PCP in the low-dimensional space.

Alternatively, the coordinate optimization device 105 may use the technique described in NPL 2, after computing the coordinates of each low-dimensional PCP using principal component analysis or Isomap. In this case, the coordinate optimization device 105 creates a network structure for connecting each low-dimensional PCP arranged at the coordinates computed using principal component analysis or Isomap, and performs the same process as described above. By creating the network structure and deciding the position of each low-dimensional PCP as described above after computing the coordinates of each low-dimensional PCP using principal component analysis or Isomap in this way, the coordinate optimization device 105 can optimize the arrangement position of each low-dimensional PCP. This contributes to improved viewability of each low-dimensional PCP.

The output device 106 outputs the computed low-dimensional PCPs and their arrangement as the optimum visualization output 108. For example, the output device 106 may output an image in which each low-dimensional PCP is arranged at its optimum coordinates. Though the output device 106 may display such an image on, for example, a display device, the output mode of the output device 106 is not particularly limited. For instance, the output device 106 may output the image by print.

The data input device 101, the input data storage unit 102, the low-dimensional PCP creation device 103, the inter-PCP feature value computation device 104, the coordinate optimization device 105, and the output device 106 may each be an independent device. As an alternative, these devices may be realized by a computer that includes an interface device serving as the data input device 101 and a storage device serving as the input data storage unit 102. In such a case, the computer may read a multidimensional data visualization program and, according to the program, realize the operation of each device described above. The multidimensional data visualization program may be stored in a computer readable recording medium.

The following describes a procedure according to the present invention. FIG. 4 is a flowchart showing an example of the procedure according to the present invention. When the input data 107 is input to the data input device 101, the input data storage unit 102 stores the input data 107 (step S1).

Next, the low-dimensional PCP creation device 103 computes the plurality of low-dimensional PCPs based on the input data 107 (step S2).

Next, the inter-plot feature value computation device 104 computes the inter-PCP feature value for each low-dimensional pair (step S3).

Next, the coordinate optimization device 105 computes the low-dimensional coordinates of each low-dimensional PCP, using the inter-PCP feature value computed in step S3 (step S4).

The output device 106 then outputs the optimum visualization output 108 (step S5). The output device 106 outputs the image in which each low-dimensional PCP is arranged at its optimum low-dimensional coordinates.

The following describes an example of a structure of the low-dimensional PCP creation device 103 for computing the plurality of low-dimensional PCPs. FIG. 5 is a block diagram showing the example of the structure of the low-dimensional PCP creation device 103. The low-dimensional PCP creation device 103 includes a data input device 201, an input data storage unit 202, a dimension division device 203, a low-dimensional PCP construction device 204, and an output device 205.

The data input device 201 is an interface device for inputting input data 206. The input data 206 is the multidimensional data (D-dimensional data) stored in the input data storage unit 102 (see FIG. 1). The multidimensional data is the multidimensional data input to the multidimensional data visualization apparatus 1 (see FIG. 1), and the number of pieces of data of the multidimensional data is N. The parameter necessary for analysis may also be input to the data input device 201.

The input data storage unit 202 is a storage device in the low-dimensional PCP creation device 103 for storing the multidimensional data input as the input data 206.

The dimension division device 203 divides the D dimensions constituting the multidimensional data, into a plurality of groups each having a small number of dimensions. The number of groups is denoted by M. In the case of dividing the D dimensions into the plurality of groups, the dimension division device 203 performs the division so as to satisfy the following first and second conditions. The first condition is that, in each individual group obtained by division, the dimensions belonging to the same group have as much information (e.g. correlation, isolation) as possible. The second condition is that the dimensions belonging to different groups have as little information as possible.

In the case of dividing the D dimensions into the plurality of groups so as to satisfy these conditions, the dimension division device 203 may operate as follows. The concept of conditional independence is introduced in the below-mentioned operation of the dimension division device 203. It is assumed here that the number of variables corresponding to the dimensions of the observation data is D. The dimension division device 203 determines whether or not conditional independence holds for an arbitrary combination of the D variables. The dimension division device 203 creates the groups so that two variables which are not independent of each other when an arbitrary variable set is given belong to the same group. Here, the concept of submodularity may be introduced to prevent the situation where, when there are many variables, an extremely large amount of computation is required due to a large number of variable combinations.

The dimension division device 203 determines the conditional independence as follows. When three arbitrary subsets not overlapping each other in the D variables are given, the three sets are denoted by X_A, X_B, and X_C. The dimension division device 203 computes conditional mutual information content I (X_A, X_B|X_C) using these sets. In the case where the value of the conditional mutual information content is very close to 0, the dimension division device 203 determines that variable sets X_A and X_B are conditionally independent when X_C is given. Whether or not the value of the conditional mutual information content is very close to 0 may be determined by comparing the value of the conditional mutual information content with a predetermined threshold.

As a specific example, the case where the dimension division device 203 groups five variables {X_1, X_2, . . . , X_5} is described below. First, the dimension division device 203 sets a conditioning variable set to {X_1, X_2}. Note that the “conditioning variable set” corresponds to X_C mentioned above. The dimension division device 203 greedily sets the conditioning variable set. The dimension division device 203 computes the conditional mutual information content I (X_3, {X_4, X_5}| {X_1, X_2}). Suppose this value is 0 (or very close to 0). In such a case, the dimension division device 203 adds the “conditioning variable set” to each of the two sets other than the “conditioning variable set”, thereby dividing the original variable set into two sets. In this example, the dimension division device 203 divides the set of the five variables into {X_1, X_2, X_3} and {X_1, X_2, X_4, X_5}. The dimension division device 203 repeats the same process for each variable set obtained by division. In the case where no more division is possible for a variable set obtained by division, the above-mentioned repetitive process ends for the variable set. For instance, in the above example, suppose the dimension division device 203 further divides {X_1, X_2, X_4, X_5} into {X_4} and {X_2, X_4, X_5}. If no more division is possible for any of {X_1, X_2, X_3}, {X_1, X_4}, and {X_2, X_4, X_5}, the dimension division device 203 ends the variable set division. In this example, the five variables are divided into three groups.

The low-dimensional PCP construction device 204 constructs, for each individual group obtained by the division process by the dimension division device 203, a low-dimensional PCP using the dimensions corresponding to the variables that belong to the group. For example, for one group {X_1, X_4}, the low-dimensional PCP construction device 204 creates a low-dimensional PCP that includes an axis corresponding to variable X_1 and an axis corresponding to variable X_4. In the same manner, the low-dimensional PCP construction device 204 creates a low-dimensional PCP for each of the other groups.

The output device 205 outputs a low-dimensional PCP creation result 207 obtained by the low-dimensional PCP construction device 204 (i.e. each low-dimensional PCP created by the low-dimensional PCP construction device 204), to the inter-PCP feature value computation device 104 (see FIG. 2).

Thus, the plurality of low-dimensional PCPs can be created from the D-dimensional data by the low-dimensional PCP creation device 103 having the structure illustrated in FIG. 5.

The data input device 201, the input data storage unit 202, the dimension division device 203, the low-dimensional PCP construction device 204, and the output device 205 in the low-dimensional PCP creation device 103 may each be an independent device. As an alternative, these devices may be realized by the computer operating according to the multidimensional data visualization program, together with the devices shown in FIG. 2.

According to the present invention, the inter-PCP feature value computation device 104 computes the feature value which serves as an index for arranging each low-dimensional PCP from a desired viewpoint. The coordinate optimization means 105 computes the coordinates for arranging each low-dimensional PCP in the low-dimensional space, using the feature value. Therefore, the distribution of data can be visualized so as to enable understanding of the relationships between the input dimensions in the input multidimensional data. In addition, from which viewpoint the high-dimensional data is visualized can be adjusted by changing the type of the feature value.

If the multidimensional data is directly represented by a PCP, the resulting PCP is too horizontally long to be contained within one screen. According to the present invention, however, the plurality of low-dimensional PCPs are created from the multidimensional data, where each individual low-dimensional PCP is kept from being horizontally long. By arranging such low-dimensional PCPs on the screen, it is possible to prevent the situation where, when visualizing the multidimensional data, the multidimensional data is presented by a horizontally long PCP that cannot be contained within one screen.

Furthermore, according to the present invention, the same axis overlaps between two or more low-dimensional PCPs. Hence, even when an axis is highly correlated with three or more axes, its correlation with each of these axes can be represented appropriately.

The following describes a minimum structure according to the present invention. FIG. 6 is a block diagram showing an example of a minimum structure of a multidimensional data visualization apparatus according to the present invention. The multidimensional data visualization apparatus includes low-dimensional parallel coordinates plot creation means 71, feature value computation means 72, and coordinate computation means 73.

The low-dimensional parallel coordinates plot creation means 71 (e.g. the low-dimensional PCP creation device 103) creates, from input multidimensional data, a plurality of low-dimensional parallel coordinates plots (low-dimensional PCPs) that are each a graph in which data relating to part of dimensions in the multidimensional data is represented by a parallel coordinates plot.

The feature value computation means 72 (e.g. the inter-PCP feature value computation device 104) computes, for each pair of low-dimensional parallel coordinates plots, a feature value indicating a relationship between the low-dimensional parallel coordinates plots forming the pair.

The coordinate computation means 73 (e.g. the coordinate optimization device 105) computes coordinates at which each low-dimensional parallel coordinates plot is arranged, based on the feature value computed by the feature value computation means 72.

According to such a structure, a data distribution in an input space of high-dimensional data can be visualized so as to enable understanding of relationships between input dimensions.

Moreover, the low-dimensional parallel coordinates plot creation means 71 may include: variable grouping means (e.g. the dimension division device 203) for dividing variables respectively corresponding to the dimensions of the input multidimensional data, into a plurality of groups; and low-dimensional parallel coordinates plot derivation means (e.g. the low-dimensional PCP construction device 204) for deriving, for each group obtained by the variable grouping means, a low-dimensional parallel coordinates plot by creating a parallel coordinates plot that includes, as axes, dimensions corresponding to variables that belong to the group, wherein the variable grouping means performs a division process of dividing a plurality of variables into two groups so as to be conditionally independent when part of the plurality of variables is set as a conditioning variable set and, for each group after the division process, repeats the division process on variables that belong to the group.

The exemplary embodiment described above may be partly or wholly described in the following supplementary notes, though the present invention is not limited to the following.
(Supplementary note 1) A multidimensional data visualization apparatus including: a low-dimensional parallel coordinates plot creation unit for creating, from input multidimensional data, a plurality of low-dimensional parallel coordinates plots that are each a graph in which data relating to part of dimensions in the multidimensional data is represented by a parallel coordinates plot; a feature value computation unit for computing, for each pair of low-dimensional parallel coordinates plots, a feature value indicating a relationship between the low-dimensional parallel coordinates plots forming the pair; and a coordinate computation unit for computing coordinates at which each low-dimensional parallel coordinates plot is arranged, based on the feature value computed by the feature value computation unit.
(Supplementary note 2) The multidimensional data visualization apparatus according to claim 1, wherein the low-dimensional parallel coordinates plot creation unit includes: a variable grouping unit for dividing variables respectively corresponding to the dimensions of the input multidimensional data, into a plurality of groups; and a low-dimensional parallel coordinates plot derivation unit for deriving, for each group obtained by the variable grouping unit, a low-dimensional parallel coordinates plot by creating a parallel coordinates plot that includes, as axes, dimensions corresponding to variables that belong to the group, and wherein the variable grouping unit performs a division process of dividing a plurality of variables into two groups so as to be conditionally independent when part of the plurality of variables is set as a conditioning variable set and, for each group after the division process, repeats the division process on variables that belong to the group.

This application claims priority based on Japanese Patent Application No. 2012-22112 filed on Feb. 3, 2012, the disclosure of which is incorporated herein in its entirety.

Though the present invention has been described with reference to the above exemplary embodiment, the present invention is not limited to the above exemplary embodiment. Various changes understandable by those skilled in the art within the scope of the present invention can be made to the structures and details of the present invention.

### INDUSTRIAL APPLICABILITY

The present invention is preferably applied to a multidimensional data visualization apparatus for visualizing multidimensional data so as to be easily recognizable by humans.

### REFERENCE SIGNS LIST

1 multidimensional data visualization apparatus

101 data input device

102 input data storage unit

103 low-dimensional PCP creation device

104 inter-PCP feature value computation device

105 coordinate optimization device

106 output device

201 data input device

202 input data storage unit

203 dimension division device

204 low-dimensional PCP construction device

205 output device

1. A multidimensional data visualization apparatus comprising:
a low-dimensional parallel coordinates plot creation unit for creating, from input multidimensional data, a plurality of low-dimensional parallel coordinates plots that are each a graph in which data relating to part of dimensions in the multidimensional data is represented by a parallel coordinates plot;
a feature value computation unit for computing, for each pair of low-dimensional parallel coordinates plots, a feature value indicating a relationship between the low-dimensional parallel coordinates plots forming the pair; and
a coordinate computation unit for computing coordinates at which each low-dimensional parallel coordinates plot is arranged, based on the feature value computed by the feature value computation unit.

2. The multidimensional data visualization apparatus according to claim 1, wherein the low-dimensional parallel coordinates plot creation unit includes:
a variable grouping unit for dividing variables respectively corresponding to the dimensions of the input multidimensional data, into a plurality of groups; and
a low-dimensional parallel coordinates plot derivation unit for deriving, for each group obtained by the variable grouping unit, a low-dimensional parallel coordinates plot by creating a parallel coordinates plot that includes, as axes, dimensions corresponding to variables that belong to the group, and
wherein the variable grouping unit performs a division process of dividing a plurality of variables into two groups so as to be conditionally independent when part of the plurality of variables is set as a conditioning variable set and, for each group after the division process, repeats the division process on variables that belong to the group.

3. A multidimensional data visualization method comprising:
creating, from input multidimensional data, a plurality of low-dimensional parallel coordinates plots that are each a graph in which data relating to part of dimensions in the multidimensional data is represented by a parallel coordinates plot;
computing, for each pair of low-dimensional parallel coordinates plots, a feature value indicating a relationship between the low-dimensional parallel coordinates plots forming the pair; and
computing coordinates at which each low-dimensional parallel coordinates plot is arranged, based on the feature value.

4. The multidimensional data visualization method according to claim 3, comprising:
executing a variable grouping process of dividing variables respectively corresponding to the dimensions of the input multidimensional data, into a plurality of groups; and
deriving, for each group obtained in the variable grouping process, a low-dimensional parallel coordinates plot by creating a parallel coordinates plot that includes, as axes, dimensions corresponding to variables that belong to the group,
wherein, in the variable grouping process, a division process of dividing a plurality of variables into two groups so as to be conditionally independent when part of the plurality of variables is set as a conditioning variable set is performed and, for each group after the division process, the division process is repeated on variables that belong to the group.

5. A non-transitory computer-readable recording medium in which a multidimensional data visualization program is recorded, the multidimensional data visualization program causing a computer to execute:
a low-dimensional parallel coordinates plot creation process of creating, from input multidimensional data, a plurality of low-dimensional parallel coordinates plots that are each a graph in which data relating to part of dimensions in the multidimensional data is represented by a parallel coordinates plot;
a feature value computation process of computing, for each pair of low-dimensional parallel coordinates plots, a feature value indicating a relationship between the low-dimensional parallel coordinates plots forming the pair; and
a coordinate computation process of computing coordinates at which each low-dimensional parallel coordinates plot is arranged, based on the feature value computed in the feature value computation process.

6. The non-transitory computer-readable recording medium in which the multidimensional data visualization program is recorded according to claim 5, wherein, the multidimensional data visualization program causing the computer to execute in the low-dimensional parallel coordinates plot creation process:
a variable grouping process of dividing variables respectively corresponding to the dimensions of the input multidimensional data, into a plurality of groups; and
a low-dimensional parallel coordinates plot derivation process of deriving, for each group obtained in the variable grouping process, a low-dimensional parallel coordinates plot by creating a parallel coordinates plot that includes, as axes, dimensions corresponding to variables that belong to the group, and
wherein, in the variable grouping process, the computer is caused to execute a division process of dividing a plurality of variables into two groups so as to be conditionally independent when part of the plurality of variables is set as a conditioning variable set and, for each group after the division process, repeat the division process on variables that belong to the group.
